(19) United States
(12) Patent Application Publication
(10) Pub. No.: US 2023/0120846 A1
(43) Pub. Date: Apr. 20, 2023

(54) System and Method for Temporarily Renting Home Yard Properties

(71) Applicant: Fiona Mao, Aurora, TX (US)

(72) Inventor: Fiona Mao, Aurora, TX (US)

(21) Appl. No.: 18/046,546

(22) Filed: Oct. 14, 2022

Related U.S. Application Data
(60) Provisional application No. 63/255,523, filed on Oct. 14, 2021.

(51) Int. Cl. G06Q 30/06; G06Q 10/02; G06Q 20/10; G06Q 20/02; G06F 16/955

(52) U.S. Cl. CPC G06Q 30/0645; G06Q 10/02; G06Q 20/102; G06Q 20/02; G06F 16/955

(57) ABSTRACT

The present invention relates to a home yard or outdoor renting system and an application for homeowners and renters. The system enables homeowners to list their outdoor areas for rent in the system using the application or website. The prospective renters can search for listed outdoor areas for rent and book a property by paying an advance payment. The system can be used by a plurality of service providers for offering their services which can be availed by renters for providing services at a rented property. The system helps in generating additional income for property owners and promotes local business partners while offering a safe, celebratory space for individuals who want to celebrate life events, pool parties, picnics, and more.

### CROSS-REFERENCE TO RELATED APPLICATION

The present application claims priority to, and the benefit of, U.S. Provisional Application No. 63/255,523, which was filed on Oct. 14, 2021 and is incorporated herein by reference in its entirety.

### FIELD OF THE INVENTION

The present invention relates generally to the field of renting outdoor properties of a home for organizing parties, picnics, and more. More specifically, the present invention relates to a computer implemented method and system to allow users to rent another person's front yard, backyard, patio, deck, or pool area for organizing events and parties. Homeowners can list their outdoor areas for rent and prospective renters can then use the system to search for available properties for rent from a few hours to up to a couple of days. The system can be used by chefs/restaurants, event planners, musicians, tent owners, photographers, candle sellers, painters, and more for offering their services which can be availed by renters. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals host outdoor parties to celebrate season changes especially when the summer season approaches. Younger individuals like to do pool parties with good music and even businesses like to host pool parties. It is common for individuals to use a backyard, a front yard, a deck, a patio, and a home pool for hosting outdoor parties. For organizing parties, individuals use a theme, removable furniture, hire chefs, event planners, and more. Arranging all such arrangements is not only difficult but is also time consuming as an organizer needs to go to different stores and websites for arrangements. Individuals desire a system and method that enable organizers to find and arrange various arrangements for parties easily and function as a single stop/source solution.

Individuals who love to organize parties but do not have their own home find it challenging to identify an affordable and reliable location. Public parks lack intimacy and renting banquet halls or pavilions are expensive. Such individuals desire a way to obtain an economic and safe location for their events and parties.

Landlords and homeowners generally have unused outdoor spaces that require maintenance and are left unused for long periods. Such individuals desire a way so that they can temporarily rent out their unused outdoor spaces for a few hours or for a day or two. A way to generate revenue is to rent out such spaces to individuals who want to organize parties in outdoor properties while not spending much time in identifying service providers like chefs, event planners, photographers, and more.

Therefore, there exists a long felt need in the art for a system and method that can assist landlords in temporarily renting out their unused outdoor spaces. There is also a long felt need in the art for a system and method that helps individuals who want to organize parties and events in outdoor spaces to rent economic and safe outdoor spaces. Additionally, there is a long felt need in the art for a system and method that offers a way of generating additional income for landlords and homeowners. Moreover, there is a long felt need in the art for a system and method that helps renters who are party organizers in identifying service providers and rental services. Further, there is a long felt need in the art for a system and method that enables both landlords and renters to connect with each other in a safe and convenient manner. Finally, there is a long felt need in the art for a system and method that enables individuals to find places to rent without renting expensive banquet halls while enabling landlords to create an additional income.

The subject matter disclosed and claimed herein, in one embodiment thereof, comprises a computer implemented method for temporarily renting out unused home yard space for generating income. The unused spaces are rented by individuals for organizing parties and picnics and thus obviates renting expensive banquet halls and pavilions. The method comprising the steps of receiving, via a computer implemented application, home yard property details from a plurality of property owners; receiving, via the computer implemented application, a request for renting a home yard property from a renter; displaying, by the computer implemented application, a list of the home yard properties matching with the renter's request; receiving, via the application, a selection of a home yard property from the renter; receiving, via the application, an advanced payment for confirming booking of the selected property; and sending a notification, via the application, to a property owner of the property selected by the renter. The renter can connect and select one or more service providers for providing services at the selected property for organizing and managing the event.

In this manner, the landlord and home yard or outdoor renting system and associated application of the present invention accomplish all of the forgoing objectives and provide a mobile/web application designed to allow users to rent another person's front yard, backyard, patio, deck, and/or pool area. Homeowners list their outdoor areas for rent and prospective renters can select and choose a property. The system provides a place to build a unique, nature focused experience for renters while bringing in additional income for homeowners, creating a win-win situation for homeowners, renters, and service providers which are conveniently selected by renters.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer implemented method for temporarily renting out unused home yard space or home amenities for generating income. The method comprising the steps of receiving, via a computer implemented application, home yard property details from a plurality of property owners; receiving, via the computer implemented application, a request for renting a home yard property from a renter; displaying, by the computer implemented application, a list of the home yard properties matching with the renter's request; receiving, via the application, a selection of a home yard property from the renter; receiving, via the application, an advanced payment for confirming booking of the selected property; and sending a notification, via the application, to a property owner of the property selected by the renter.

In yet another embodiment, receiving the property details includes receiving location, dimensions, images, and rent for the property.

In yet another embodiment, the home yard includes at least one of pool area, patio, deck, backyard area, or front yard area.

In yet another embodiment, the computer implemented method further comprising receiving, from a service provider, service offerings and corresponding prices for listing on the computer implemented application wherein a renter can select one or more service providers for providing services at a selected property.

In yet another embodiment, the service providers include at least event planners, tent owners, photographers, candle sellers, painters, musicians, portable toilet providers, food and beverage trucks/caterers, rental services, and more.

In yet another embodiment, a computer-readable storage medium storing non-transitory computer-executable program instructions, wherein when executed by a computing device, the non-transitory computer-executable program instructions cause a processor of the computing device to perform operations comprising receiving, from a user device, a home yard property details; receiving from another user device, a request for renting a home yard property; displaying, a plurality of home yard properties matching with the renter's request; receiving a selection of one of the properties from said displayed properties and receiving a payment from the renter for confirming booking of the selected property.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a home yard celebration renting system of the present invention in accordance with the disclosed architecture;

FIG. 2 illustrates an exemplary user interface provided by the home yard or outdoor renting application of the present invention for logging into the system in accordance with the disclosed architecture;

FIG. 3 illustrates an exemplary user interface of the home yard rent application for enabling a homeowner to list outdoor properties for renting out to earn money in accordance with the disclosed architecture;

FIG. 4 illustrates an exemplary user interface of the home yard celebrations application enabling a renter to search and view home yard areas for renting in accordance with the disclosed architecture;

FIG. 5 illustrates an exemplary user interface of the home yard celebrations application enabling a renter to view details of a property listed on the application for renting out in accordance with the disclosed architecture;

FIG. 6 illustrates an exemplary user interface of the home yard celebrations application enabling a renter to search third-party service providers for organizing a party and to rent out property in accordance with the disclosed architecture;

FIG. 7 illustrates an exemplary user interface of the home yard celebrations application enabling a renter to make an advanced payment for renting out properties in accordance with the disclosed architecture;

FIG. 8 illustrates a flow chart depicting a process for renting a property by a renter using the system of the present invention in accordance with the disclosed architecture;

FIG. 9 illustrates a flow chart depicting a process for connecting the service providers and rental services with the renters using the home yard celebration system of the present invention in accordance with the disclosed architecture; and

FIG. 10 depicts an exemplary computing device for installing the home yard or outdoor renting application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system and method that assists landlords in temporarily renting out their unused and/or extra outdoor spaces. There is also a long felt need in the art for a system and method that help individuals who want to organize parties and events in outdoor spaces to rent economic and safe outdoor spaces. Additionally, there is a long felt need in the art for a system and method that offers a way of generating additional income for landlords and homeowners. Moreover, there is a long felt need in the art for a system and method that helps renters who are party organizers in identifying service providers and rental services. Further, there is a long felt need in the art for a system and method that enables both landlords and renters to connect with each other in a safe and convenient manner. Finally, there is a long felt need in the art for a system and method that enables individuals to find places to rent without renting expensive banquet halls, while enabling landlords and homeowners to create an additional income.

The present invention, in one exemplary embodiment, is a computer-readable storage medium storing non-transitory computer-executable program instructions, wherein when executed by a computing device, the non-transitory computer-executable program instructions cause a processor of the computing device to perform operations comprising receiving, from a user device, a home yard property details; receiving from another user device, a request for renting a home yard property; displaying, a plurality of home yard properties matching with the renter's request; receiving a selection of one of the properties from said displayed properties and receiving a payment from the renter for confirming booking of the selected property.

Embodiments of the present invention can be used in conjunction with various devices, for example, a personal computer (PC), a desktop computer, a laptop, a notebook computer, a tablet, a server computer, a handheld computer, any handheld electronic device, a personal digital assistant (PDA) device, a handheld PDA device, an on-board device, a mobile or portable device, a non-mobile or non-portable device, a display unit, a monitor, a wireless communication device, and more.

Although embodiments of the invention are not limited in this regard, the term “user” as used herein may include, for example, a homeowner, a renter, a property owner, a service provider, or the like.

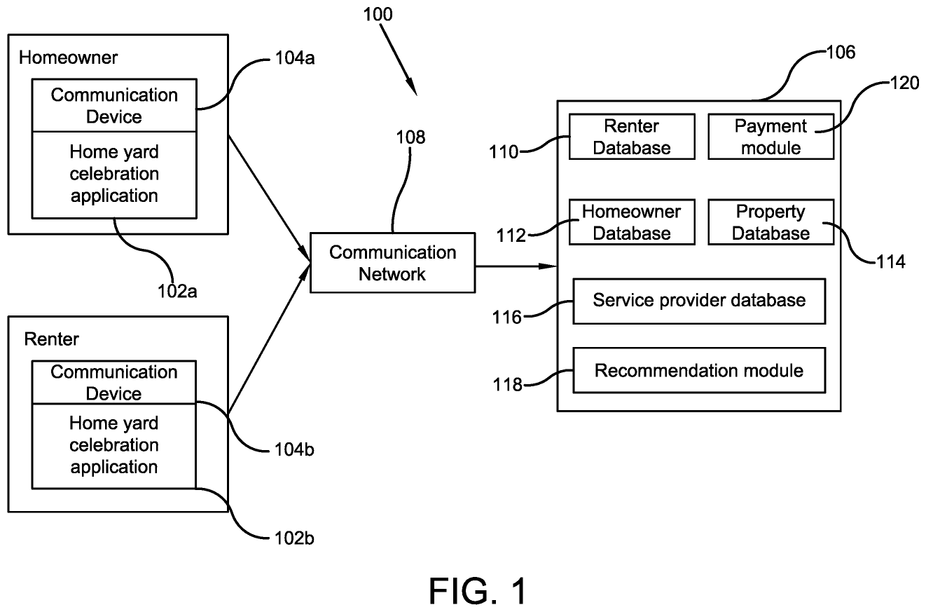

Referring initially to the drawings, FIG. 1 illustrates a schematic view of a home yard celebration/reservation/event renting system of the present invention in accordance with the disclosed architecture. The home yard celebration renting system 100 of the present invention is configured to provide homeowners and renters with a renting system enabling homeowners or property owners to list their outdoor areas, such as pool, patio, deck, backyard, front yard, courts, and more for rent that can be accessed by prospective renters for renting for a few hours or even a day(s) at a time. The system 100 provides a mobile/web application that brings together property owners and renters and helps in generating additional income for property owners and promotes local business partners like event planners, musicians, photographers, caterers, and more.

The system 100 is configured to be used by property owners and renters but can be used by other users such as event planners, tent owners, photographers, candle sellers, painters, caterers, and more. The system 100 is accessed by a user registered as a property owner using a computer implemented home yard or outdoor renting software application 102a on a computing device 104a. The functionality provided by the computer implemented home yard or outdoor renting software application 102a can also be provided using a website that can be accessed using a URL on a web browser. Similarly, the system 100 is accessed by a renter using a computer implemented home yard or outdoor renting software application 102b on a computing device 104b. The software applications 102a, 102b may provide similar or different user interfaces and can provide similar functionality enabling a user to use the application both as a property owner and as a tenant or renter.

The applications 102a, 102b are configured to connect to a server 106 using a communication network 108. The communication network 108 can be one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, discrete multi-tone (DMT), Bluetooth®, global positioning system (GPS), Wi-Fi, ZigBee™, global system for mobile communication (GSM), 2G, 2.5G, 3G, 3.5G, 4G, 5G, 6G, or the like.

The server 106 can be a centralized server, distributed server, cloud server, or the like. The server 106 is configured to provide the user interfaces and functionality to the users of the system 100 using a plurality of integrated software and hardware modules as described in the present disclosure. The server 106 includes a renter database 110 for storing renter profiles including name, address, contact details, rent payment history, and more. Once a user is registered as a renter in the system, the information of the user is stored in the renter database 110. It should be noted that in some embodiments, a user can rent out an outside area without registering in the system.

A homeowner database 112 is configured for storing homeowner profiles including landlord names, associated properties, contact details, reviews, and more. A property database 114 stores information of all the properties of the users registered as property owners in the system 100. The database 114 also stores details such as dimensions, specifications, rent charge or costs, rent duration, photos, and more of the properties for enabling a renter to easily review the property and amenities and helps in deciding to rent out a property.

The server 106 includes a service provider database 116 configured for storing information of third-party service providers like chefs, restaurants, event planners, tent owners, photographers, candle sellers, painters, musicians and more. The third-party service providers can be contacted by a prospective renter for help in organizing a party at a rented place taken on rent using the home yard celebration system 100.

The system 100 uses a recommendation module 118 for recommending prospective renters a plurality of properties based on the profile of the renters. The recommendation module 118 may use machine learning and artificial intelligence for recommending properties and service providers to renters. A payment module 120 enables the renters to perform payment in advance before renting out a property using the system 100. The payment module 120 also facilitates the property owners and service providers to receive payments made by the renters. The payment module 120 can be in the form of a payment gateway and can be a third-party integration in some embodiments of the present invention.

It should be appreciated that the home yard celebrations application and system allow landowners to use their unused outdoor spaces for renting out and earn revenue. The renters can reserve these spaces for party or small event without renting out expensive banquet halls or using public parks and more. The application can be used by chefs/restaurants, event planners, tent owners, photographers, candle sellers, caterers, and painters to advertise their business and connect with potential clients for whose events their services may be sought out.

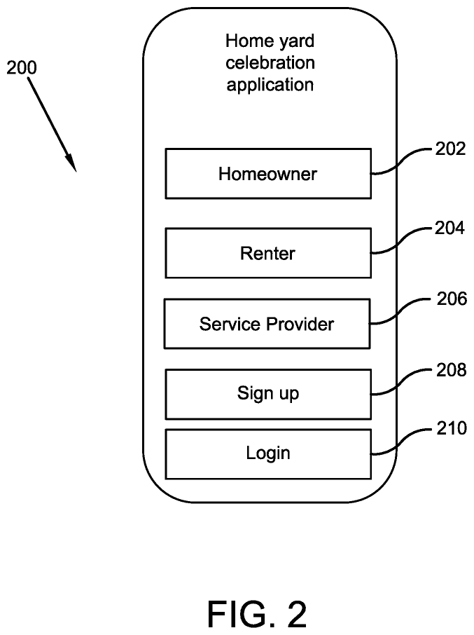

FIG. 2 illustrates an exemplary user interface provided by the home yard or outdoor renting application of the present invention for logging into the system in accordance with the disclosed architecture. As illustrated, the exemplary user interface 200 is the first display visible to a user and has a selectable homeowner or property owner tab 202, a selectable renter tab 204, and a selectable service provider tab 206. A user, preferably, logs into the application as one of the homeowner, renter, or service provider. Accordingly, based on the role selected by a user, the user interfaces are displayed to the user for providing required functionality to the user.

A sign-up button 208 is used for a user to sign up to the system 100. Accordingly, when the user registered as a homeowner, then, the application provides interfaces and functionality required by a homeowner for listing properties. When the user is registered as a renter, then, the application provides interfaces and functionality required by a renter for renting out one or more outdoor places. When the user is registered as a service provider, then, the application provides interfaces and functionality required by a service provider for advertising their services and prices.

A login button 210 is positioned below the sign-up button 208 and is used for logging into the application. The functionality provided by home yard celebrations application is available to users after the users are securely logged into the system.

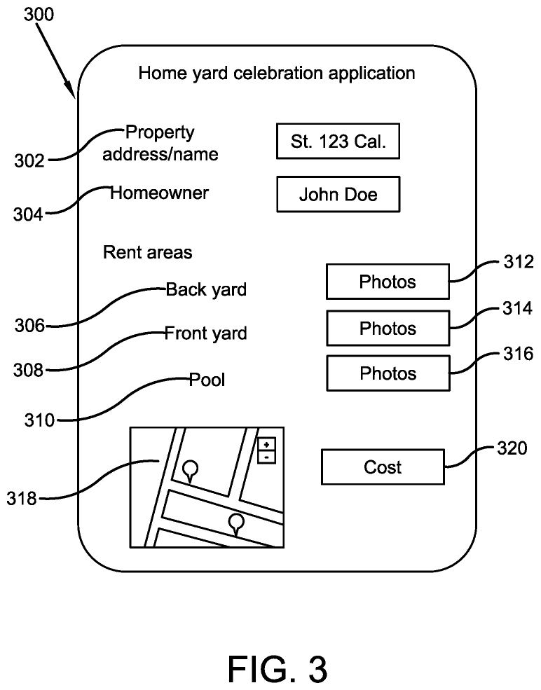

FIG. 3 illustrates an exemplary user interface of the home yard rent application for enabling a homeowner to list outdoor properties for renting out to earn income in accordance with the disclosed architecture. As illustrated, the user interface 300 provides a property address 302 in which property details like name and address are added. Homeowner name 304 is added for adding a correspondence or association between the property and the homeowner. The interface 300 enables a plurality of home yard areas to be listed that are available for renting out.

More specifically, the homeowner or property owner 304 can add a backyard area 306, a front yard area 308, a pool area 310, a deck area, a patio area, and/or a court area (i.e. amenities) for renting out. A plurality of photos and details, such as, duration for renting about the backyard area 306 can also be uploaded using the backyard photos button 312. Similarly, a plurality of photos and details about the front yard area 308 can also be uploaded using the front yard photos button 314. A plurality of photos and details about the pool/deck/patio area 314 can also be uploaded using the pool photos button 316, et. al.

A map area 318 is displayed on the user interface 300 for displaying accurate location of the property listed by the homeowner. A tentative cost for renting out the listed properties 306, 308, 310 can also be included using the cost button 320. The cost of the properties along with other details like photos, location, and more are configured to be publicly available to renters registered on the system 100. The details and the photos help a renter in making a decision to rent out a property.

The term “map” as used herein may include, for example, a street-based map, a road-based map, a street map, a road map, a geographical map, a vector map, a raster map, a topographic map, a city map, a digital chart, a bird's eye view map, a satellite map, a pictorial map, a 2D map, a 3D map, a traffic map, or the like.

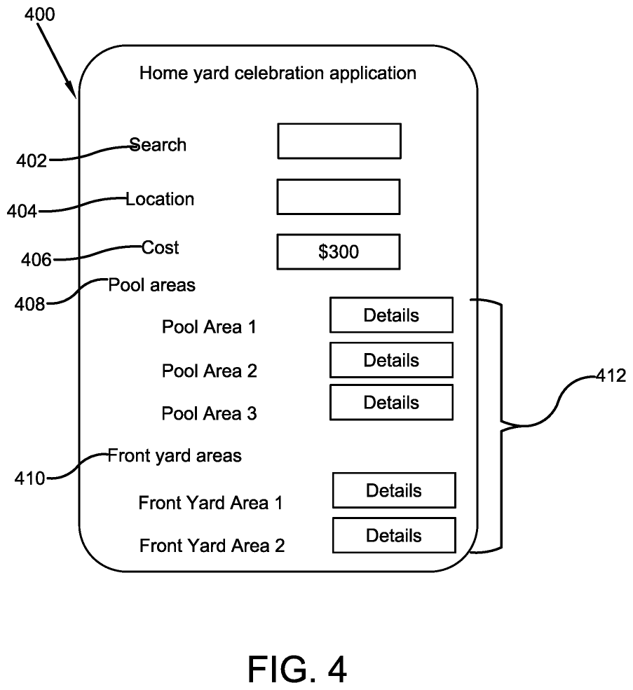

FIG. 4 illustrates an exemplary user interface of the home yard celebrations application enabling a renter to search and view home yard areas for renting in accordance with the disclosed architecture. The user interface 400 provides a search bar 402 enabling a renter to search for a property like a pool property, patio, deck, backyard, or home yard. A renter can put the search keywords in the search bar 402. For searching properties for renting out in a specific area or location, a location bar 404 is provided. The location bar 404 can also be used for locating a location on a map area using GPS functionality. For viewing properties that fall in a price range of preference of the renter, a cost box 406 is provided enabling the renter to input a cost range per hour for renting out a property.

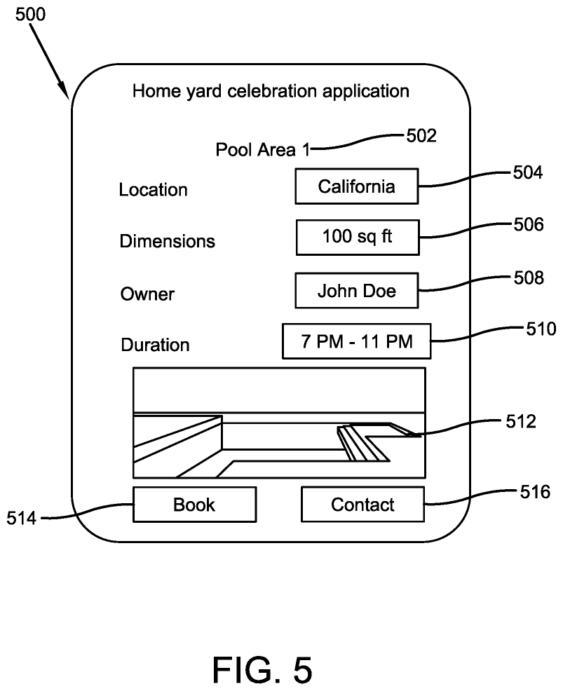

The user interface 400 is configured to provide and display a list 408 of pool areas, a list 410 of front yard areas, and a list of backyard areas (not shown) that meet the search criteria of the renter. It should be noted that only one of the pool areas, patio/deck areas, front yard areas, and backyard areas can be listed and displayed based on the search criteria of the renter. Each of the property displayed on the user interface 400 has an associated “Details” button 412 that can be used for retrieving details of a property as illustrated and described in FIG. 5.

FIG. 5 illustrates an exemplary user interface of the home yard celebrations application enabling a renter to view details of a property listed on the application for renting out in accordance with the disclosed architecture. The user interface 500 is configured to list details of a property selected by a renter on user interface 400 of FIG. 4.

As illustrated “pool/deck/patio area 1” 502 is selected by the renter and the user interface 500 displays the location 504, dimensions 506, owner details 508 and renting duration 510 for the property 502 for review. The user interface 500 also displays one or more images 512 and one or more comments/reviews (not shown) of the property. Based on review of the property, the interface 500 enables a renter to book the property by clicking on “Book” option 514 or contact the property owner by clicking on the “Contact” 516.

It should be appreciated that the application brings together property owners and renters enabling the renters to rent out properties for specific durations and having the option to set up their own décor to create a beautiful environment for their special occasions.

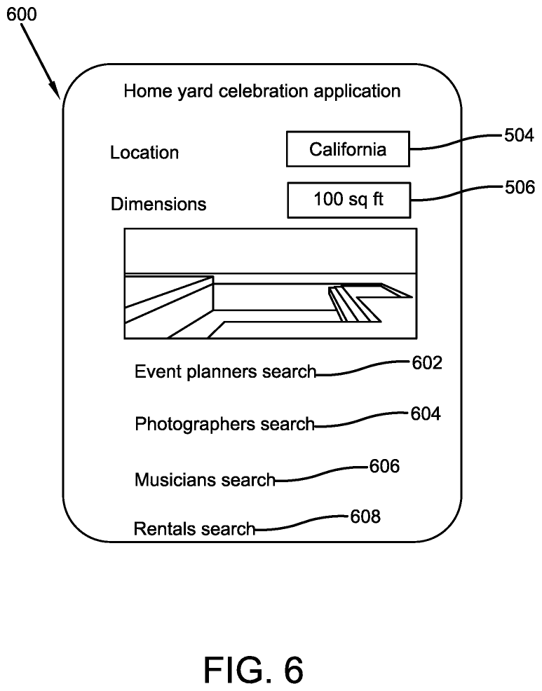

FIG. 6 illustrates an exemplary user interface of the home yard celebrations application enabling a renter to search third-party service providers for organizing a party in order to rent out property in accordance with the disclosed architecture. The exemplary user interface 600 displays the location 504 and dimensions 506 of a property selected by a renter. Also, photos and other details are also displayed to the renter on the user interface 600.

The user interface 600 displays a plurality of options for the renter to search for third-party service providers for organizing a party or an event at a property rented out by the renter. The recommendation module of the system is configured to recommend service providers available in the vicinity of the location of the property. As illustrated, an event planners search 602 enables a renter to search for companies who can provide event planning. A photographers search 604 enables a renter to search for photographers and videographers for providing services on the property. Similarly, musician search 606 is provided and rentals search 608 enables renter to search for various rentals including chairs, tables, bounce houses, food, and more. It should be appreciated that any type of third-party service providers including decorators and more can be added to the system for advertising their business and providing services to renters.

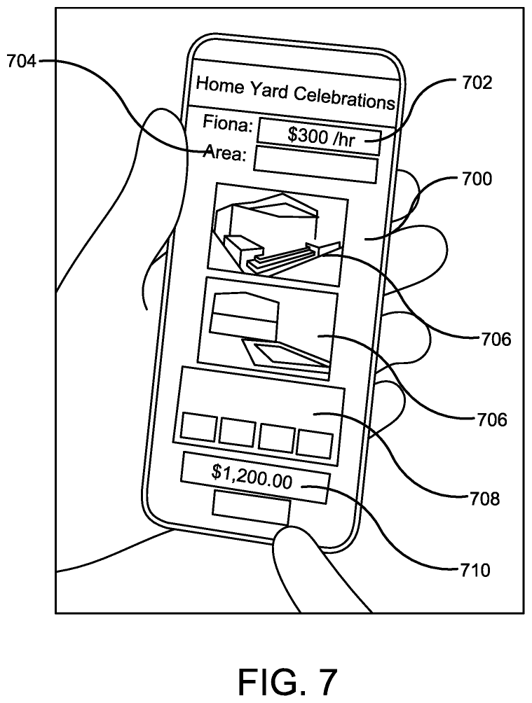

FIG. 7 illustrates an exemplary user interface of the home yard celebrations application enabling a renter to make an advanced payment for renting out properties in accordance with the disclosed architecture. The user interface 700 displays a rent amount 702 which can be a per hour basis or can be for an entire duration such as for a day. The selected rent areas 704, such as, pool, patio, deck, and/or backyard are selected and images 706 of the selected areas are displayed on the user interface 700.

Using a payment method 708 supported by payment module of the system and preferred by a renter, the total amount 710 of the rent is paid through the application in advance thus confirming a booking of the property. It should be noted that additional details like date and duration for which property is rented out, details of property owner, and more can also be displayed on the user interface 700.

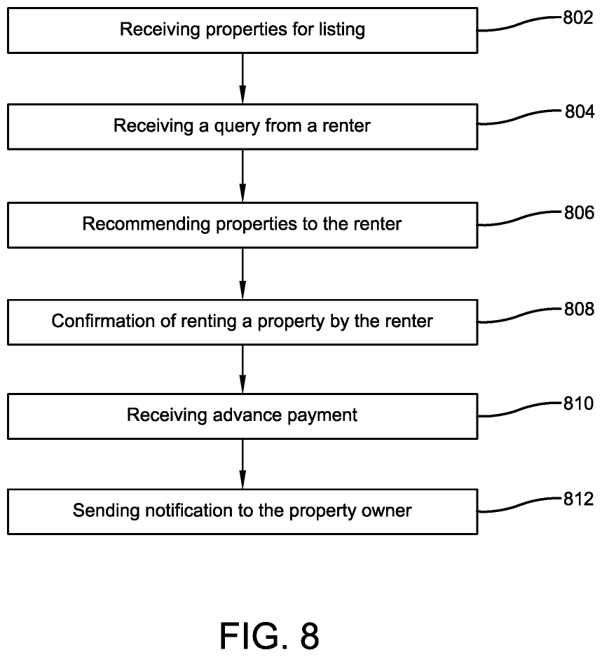

FIG. 8 illustrates a flow chart depicting a process for renting a property by a renter using the system of the present invention in accordance with the disclosed architecture. The system is configured to receive properties for renting out from a plurality of property owners using the home yard celebrations application (Step 802). The system receives a query from a renter for renting a property for a specific party, picnic, celebration, or any other event (Step 804). Thereafter, the system may recommend a plurality of properties based on the request of the renter (Step 806). Then, selection of one or more properties by the renter for rent is received by the system (Step 808). The system, then, receives advance payment of the system to confirm a booking of the property (Step 810). The system finally sends a notification along with the advance payment to the property owner of the property selected by the renter (Step 812).

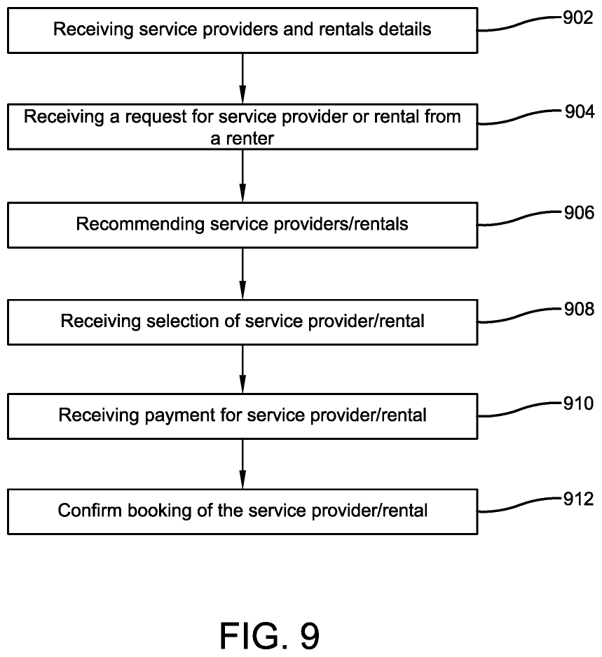

FIG. 9 illustrates a flow chart depicting a process for connecting the service providers and rental services with the renters using the home yard celebration system of the present invention in accordance with the disclosed architecture. The system is configured to receive details including services, prices, locations served, and more from a plurality of service providers and rental services (Step 902). The system is configured to receive a request for a service provider and/or rental service from a renter who has rented a property from a property owner (Step 904). Thereafter, the system based on the matching of profiles of service providers and renter request, recommends a plurality of service providers and rental services (Step 906). Then, a selection of a service provider and/or rental service is received (Step 908). The system, then, receives payment for the selected provider from the renter (Step 910) and a booking confirmation is sent to the selected service provider/rental service (Step 912).

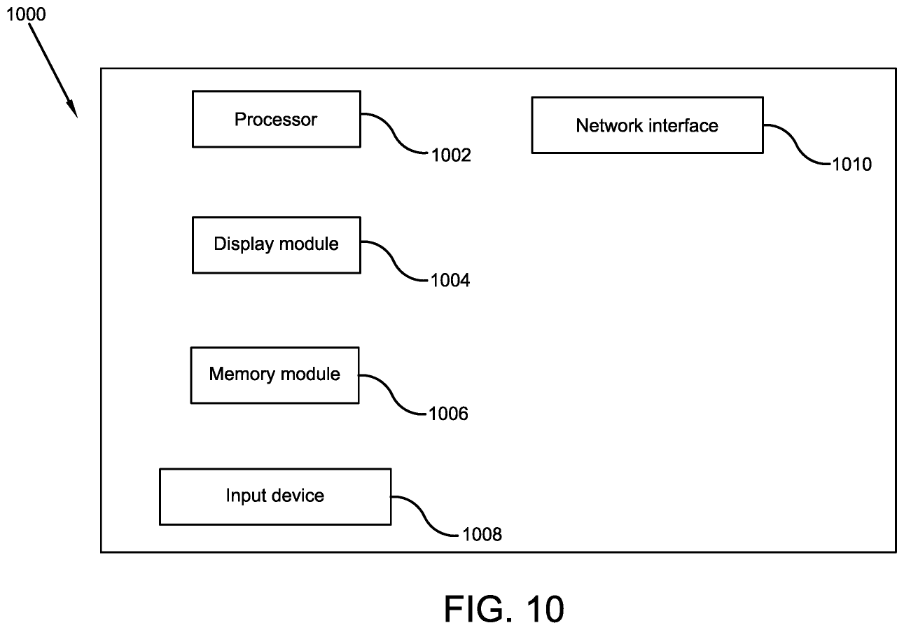

FIG. 10 depicts an exemplary computing device for installing the home yard or outdoor renting application of the present invention in accordance with the disclosed architecture. Computing device 1000 may be implemented on a handheld device, smart phone, laptop, or desktop computer and more as described in FIG. 1. The computing system 1000 includes a processor 1002 communicatively coupled to one or more memory modules 1006. The processor 1002 executes computer-executable program code of the application stored in a memory device 1006. Examples of the processor 1002 include a microprocessor, an application-specific integrated circuit (“ASIC”), a field-programmable gate array (“FPGA”), or any other suitable processing device. The processor 1002 can include any number of processing devices or cores, including a single processing device. The functionality of the computing device may be implemented in hardware, software, firmware, or a combination thereof.

The memory module 1006 includes any suitable computer-readable medium such as electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions.

The computing device 1000 executes program code that configures the processor 1002 to perform one or more of the operations described above with respect to FIGS. 2-7. The computing device 1000 also includes at least one network interface 1010. The network interface 1010 includes any device or group of devices suitable for establishing a wired or wireless data connection to one or more data networks. Non-limiting examples of the network interface 1010 include an Ethernet network adapter, a modem, or the like.

A display module 1004 is configured for displaying user interfaces of the application of the present invention and the input device 1008 can be used for submitting input to the application for processing by the processor 1002.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “home yard or outdoor renting system”, “home yard celebration system”, “backyard, front yard and pool/patio/deck renting system”, and “homeowner and renter matching system” are interchangeable and refer to the home yard or outdoor renting system 100.

Notwithstanding the forgoing, the home yard or outdoor renting system 100 of the present invention can be of any suitable size and configuration as is known in the art without affecting the overall concept of the invention, provided that it accomplishes the above stated objectives. One of ordinary skill in the art will appreciate that the home yard or outdoor renting system 100 as shown in the FIGS. are for illustrative purposes only, and that many other configurations of the home yard or outdoor renting system 100.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in-whole or in-part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments may include devices and/or systems using one or more suitable Operating Systems, for example, Microsoft Windows, Microsoft Windows CE, Microsoft Windows Embedded, Microsoft Windows Mobile, Unix, iOS, Linux, Sun Solaris, Palm OS, J2ME, BREW, an OS used by BlackBerry device(s), or other suitable Operating Systems.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for renting a property area for celebration, the property rental system comprising:
a property owner interface having a property owner database for storing owner profiles selected from a group of information consisting of a property owner, associated properties, contact details, and reviews;
a property interface having a property database for storing property profiles selected from a group of information consisting of a property, a property dimension, a property specification, a rent charge, a rent duration, a photo, and an amenity;
a renter interface having a renter database for storing renter profiles selected from a group of information consisting of a renter, a renter address, contact details, and a rent payment history;
a service provider interface having a service provider database for storing information of third-party service providers selected from a group consisting of chefs, restaurants, event planners, tent owners, photographers, candle sellers, painters, musicians, and caterers;
wherein said service provider database having contact information of said third-party service providers for contacting by said renter and said property owner; and
further wherein said system having a computer implemented renting software application and a user interface for access by said property owner, said renter, and said third-party provider.

2. The property rental system of claim 1, wherein said property profiles include outdoor profiles selected from a group consisting of a pool, a court, a deck, a patio, a front yard, and a backyard.

3. The property rental system of claim 2, wherein said computer implemented renting software application having access provided by a website accessible through a URL on a web browser.

4. The property rental system of claim 3, wherein said computer implemented renting software application connected to a server having a communication network.

5. The property rental system of claim 4, wherein said communication network having a wireless communication signal selected from a group consisting of radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, discrete multi-tone (DMT), Bluetooth®, global positioning system (GPS), Wi-Fi, ZigBee™, global system for mobile communication (GSM), 2G, 2.5G, 3G, 3.5G, 4G, 5G, and 6G.

6. The property rental system of claim 5, wherein said server selected from a group consisting of a centralized server, a distributed server, and a cloud server.

7. The property rental system of claim 2 further comprising a recommendation module for recommending to prospective said renters a plurality of said property profiles based on said renter profile.

8. The property rental system of claim 7 further comprising a payment module for accepting payments from said renters to reserve said property and at least one said third-party provider.

9. The property rental system of claim 8, wherein said payment module distributes said payments to said property owner of said property.

10. The property rental system of claim 9, wherein said payment module distributes said payments to said third-party provider.

11. A system for renting a property area for celebration, the property rental system comprising:
a property owner interface having a property owner database for storing owner profiles selected from a group of information consisting of a property owner, associated properties, contact details, and reviews;
a property interface having a property database for storing property profiles selected from a group of information consisting of a property, a property dimension, a property specification, a rent charge, a rent duration, a photo, and an amenity;
a renter interface having a renter database for storing renter profiles selected from a group of information consisting of a renter, a renter address, contact details, and a rent payment history;
a service provider interface having a service provider database for storing information of third-party service providers selected from a group consisting of chefs, restaurants, event planners, tent owners, photographers, candle sellers, painters, musicians, and caterers;
wherein said service provider database having contact information of said third-party service providers for contacting by said renter and said property owner;
wherein said system having a computer implemented renting software application and a user interface for access by said property owner, said renter, and said third-party provider;
wherein said user interface having a selectable property owner tab, a selectable renter tab, and a selectable third-party; and
further wherein a user logs into said computer implemented renting software application as one of said property owner, said renter, and said third-party provider.

12. The property rental system of claim 11, wherein said property profiles include outdoor profiles selected from a group consisting of a pool, a court, a deck, a patio, a front yard, and a backyard.

13. The property rental system of claim 12, wherein said property owner tab enabled for said property owner to list said property profiles.

14. The property rental system of claim 13, wherein said property profiles include a map area for display on said user interface to display location of said property.

15. A system for renting a property area for celebration, the property rental system comprising:
a property owner interface having a property owner database for storing owner profiles selected from a group of information consisting of a property owner, associated properties, contact details, and reviews;
a property interface having a property database for storing property profiles selected from a group of information consisting of a property, a property dimension, a property specification, a rent charge, a rent duration, a photo, and an amenity;
a renter interface having a renter database for storing renter profiles selected from a group of information consisting of a renter, a renter address, contact details, and a rent payment history;
wherein said system having a computer implemented renting software application and a user interface for access by said property owner and said renter;
wherein said property profiles include outdoor profiles selected from a group consisting of a pool, a court, a deck, a patio, a front yard, and a backyard; and
a recommendation module for recommending to prospective said renters a plurality of said property profiles based on said renter profile.

16. The property rental system of claim 15 further comprising a service provider interface having a service provider database for storing information of third-party service providers selected from a group consisting of chefs, restaurants, event planners, tent owners, photographers, candle sellers, painters, musicians, and caterers, and further wherein said service provider database having contact information of said third-party service providers for contacting by said renter and said property owner.

17. The property rental system of claim 16, wherein said computer implemented renting software application having access provided by a website accessible through a URL on a web browser.

18. The property rental system of claim 17, wherein said computer implemented renting software application connected to a server having a communication network.

19. The property rental system of claim 18 further comprising a payment module for accepting payments from said renters to reserve said property and at least one said third-party provider.

20. The property rental system of claim 19, wherein said payment module distributes said payments to said property owner of said property and to said third-party providers.
